(19) United States
(12) Patent Application Publication
(10) Pub. No.: US 2010/0278370 A1
(43) Pub. Date: Nov. 4, 2010

(54) Motor Structure of Loudspeaker

(76) Inventor: Tzu-Chung Chang, Niaosong Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/432,873

(22) Filed: Apr. 30, 2009

(51) Int. Cl. H04R 1/00

(52) U.S. Cl. 381/396

(57) ABSTRACT

A motor structure of loudspeaker comprises a magnet, a top plate, a bottom plate, and a pole piece. The magnet has two opposite sides. The top plate rests on one of the two sides of the magnet and jointly forms a central bore with the magnet. The bottom plate supports the magnet from the other side of the magnet. The pole piece is formed on the bottom plate and extends into the central bore to face an inner periphery of the top plate and to form an air gap between the pole piece and the top plate. What is characterized in that a distance between the pole piece and an axial mid-part of the inner periphery being larger than another distance between the pole piece and any one of two axial ends of the inner periphery.

### BACKGROUND OF THE INVENTION

1. Field of the Invention

The present invention relates to a motor structure of a loudspeaker and, more particularly, to a motor structure with a top plate having an uneven inner peripheral surface.

2. Description of the Related Art

FIG. 1 is a sectional view of a conventional motor structure of a loudspeaker. The said motor structure designated as “9” comprises a magnet 91, a top plate 92, a bottom plate 93, and a pole piece 94. The magnet 91 has two opposite sides, and the top plate 92 rests on one of the two sides of the magnet 91, with a central bore formed both in the magnet 91 and top plate 92. The bottom plate 93 supports the magnet 91 from the other side of the magnet 91 while the pole piece 94 is formed on the bottom plate 93 and extends into the central bore. In addition, a voice coil former 2 for a voice coil 3 to mount also extends into the central bore and peripherally surrounds the pole piece 94, with the voice coil 3 being adjacent to the top plate 92. Particularly, the voice coil 3 has an outer peripheral surface facing an inner peripheral surface of the top plate. Thereby, the top plate 92, pole piece 94, and bottom plate 93 complete a magnet circuit for the magnet 91 to project flux across an air gap between the top plate 92 and pole piece 94 and passing through the voice coil 3.

When the loudspeaker is actuated, currents of the voice coil 3 interact with the said flux to generate longitudinal force pushing or pulling the voice coil 3 to move along the pole piece 94 with the voice coil former 2. Thus, a diaphragm (not shown) attached to the voice coil former 2 moves and produces sound.

However, the conventional motor structure cannot effectively guides the flux provided by the magnet 91 to pass through the voice coil 3, and thus a long stroke and small distortion required for good performances in generation of low-frequency sounds is hard to achieve.

Please refer to FIG. 2 showing another conventional motor structure disclosed in U.S. Pat. No. 6,088,466. This conventional motor structure is similar to that one illustrated in FIG. 1, but a T-cut is formed at the pole piece 94 to provide an annular protrusion 941 at a top periphery of the pole piece 94 to prevent leakage of the flux across the air gap between the top plate 92 and pole piece 94. However, even if the distortion is suppressed, the stroke provided by this motor structure is still not long enough, and improvements in generation of low-frequency sounds are limited. Hence, there is a need for a further improvement over the conventional motor structure.

### SUMMARY OF THE INVENTION

It is therefore the primary objective of this invention to supply a motor structure of loudspeaker that centralizes a magnetic field between a pole piece and an inner periphery of a top plate, so as to provide a long stroke, small distortion, and good performances in generation of low-frequency sounds.

A motor structure of loudspeaker according to one aspect of the present invention includes a magnet, a top plate, a bottom plate, and a pole piece. The magnet has two opposite sides. The top plate rests on one of the two sides of the magnet and jointly forms a central bore with the magnet. The bottom plate supports the magnet from the other side of the magnet. The pole piece is formed on the bottom plate and extends into the central bore to face an inner periphery of the top plate and to form an air gap between the pole piece and the top plate. Besides, the inner periphery of the top plate has an axial mid-part at an axially middle belt thereof and two axial ends, with a distance between the pole piece and the axial mid-part being larger than another distance between the pole piece and any one of the two axial ends. Therefore, the uneven inner periphery of the top plate of the present invention can effectively centralize a magnetic field between the inner periphery and a pole piece.

In an example, the top plate comprises a plurality of ring elements with at least two different sizes of inner diameters and being piled with each other, with one of the ring elements having the largest inner diameter forming the axial mid-part of the top plate, and two of the ring elements having the smallest inner diameters respectively form the axial ends of the top plate. Accordingly, conventional and mass-produced washers can complete the top plate with uneven inner periphery, and additional cost in molds is saved.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a sectional view illustrating a conventional motor structure of loudspeaker;

FIG. 2 is a sectional view illustrating another conventional motor structure of loudspeaker;

FIG. 3 is a sectional view illustrating a loudspeaker with a first embodiment of a motor structure of the present invention.

FIG. 4 is a sectional view illustrating the first embodiment of a motor structure of the present invention.

FIG. 5 is a sectional view illustrating a second embodiment of a motor structure of the present invention.

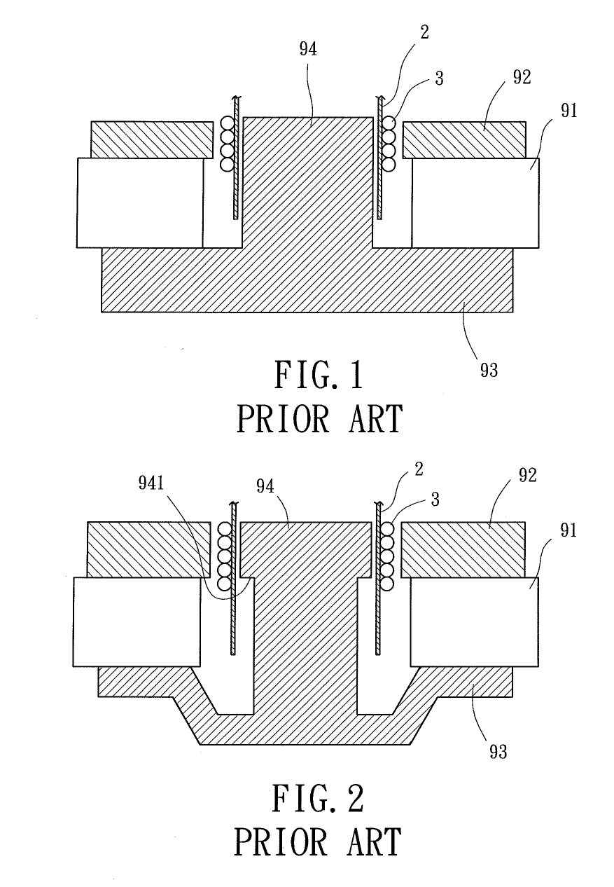

In the various figures of the drawings, the same numerals designate the same or similar parts. Furthermore, when the term “first”, “second”, “inner”, “outer” “top”, “bottom” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

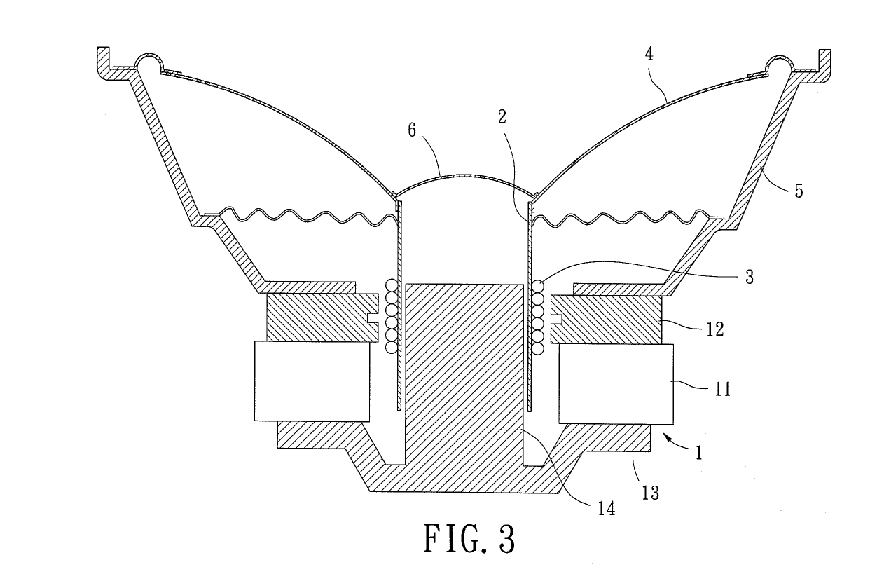

FIG. 3 illustrates a loudspeaker having a first embodiment of a motor structure of the present invention, which includes the motor structure 1, a voice coil former 2, a voice coil 3, a diaphragm 4, a frame 5, and a dust cap 6. The motor structure 1 is used for generating a magnet circuit. The voice coil former 2 extends into the motor structure 1 for holding the voice coil 3 at a position where the magnet circuit passes through. The diaphragm 4 is preferably in a cone shape having a central hold, with an inner periphery of the diaphragm 4 forming the central hold and coupling with an end of the voice coil former 2 out of the motor structure 1. The frame 5 connects and supports an outer periphery of the diaphragm 4, and is, preferably, mounted on the motor structure 1. The dust cap 6 is selectively provided and covers the central hole of the diaphragm 4.

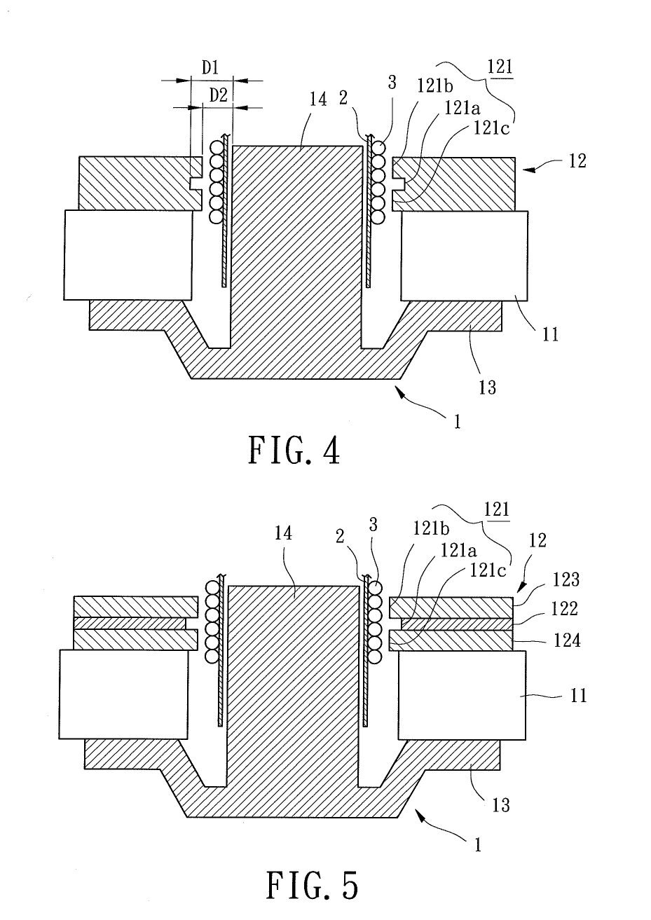

Referring to FIGS. 3 and 4 now, in the first embodiment, the motor structure 1 comprises a magnet 11, a top plate 12, a bottom plate 13, and a pole piece 14. The magnet 11 has two opposite sides, and the top plate 12 rests on one of the two sides of the magnet 11, with a central bore formed both in the magnet 11 and top plate 12. The bottom plate 13 supports the magnet 11 from the other side of the magnet 11 while the pole piece 14 is formed on the bottom plate 13 and extends into the central bore. By the above-mentioned elements, the magnet circuit produced by the motor structure 1 can be completed, and flux of the magnet circuit across an air gap between the top plate 12 and pole piece 14 can pass through the voice coil 3.

Referring to FIG. 4, please be noted that the motor structure 1 of the present invention is characterized in the shape of the top plate 12, which includes an uneven inner periphery 121 facing the pole piece 14. Specifically, the inner periphery 121 further has an axial mid-part 121a at an axially middle belt thereof, and two axial ends 121b, 121c. Besides, from the axial mid-part 121a to any one of the two axial ends 121b, 121c, the width of the air gap between the top plate 12 and pole piece 14 is decreased. For example, referring to FIG. 4, the width of the said air gap is of a first distance D1 at the axial mid-part 121a, and the width of the said air gap is of a second distance D2 at the axial end 121b, which is smaller than the first distance D1. Thereby, a belt of groove resulted from a difference between the distances D1, D2 is formed in the inner periphery 121 between the two axial ends 121b, 121c, and a magnetic field between the inner periphery 121 and the pole piece 14 is centralized, and thus leakage of flux of the magnetic field is effectively prevented. Furthermore, because the magnetic field is centralized, an axial height between the two axial ends of the top plate 12 can be increased without large decay in intensity of the magnetic field, and thus a long stroke can also be obtained. As a result, a loudspeaker with a long stroke and small distortion is made, and good performances in generation of low-frequency sounds are achieved.

Now referring to FIG. 5, a second embodiment of a motor structure of the present invention is illustrated. In this embodiment, the top plate 12 is obtained by coaxially piling a plurality of ring elements, which can be selected from washers made of magnet conductive material, and whose inner diameters are in at least two different sizes. In detail, a first ring element 122 with the largest inner diameter forms the axial mid-part 121a of the inner periphery 121 while second and third ring elements 123, 124 with smallest inner diameters form the axial ends 121b, 121c thereof. Besides, other ring elements with inner diameters in middle sizes between those of the first ring element 122 and the second ring element 123 may be serially inserted between these two ring elements 122, 123 according to the sizes of their inner diameters. In the same way, other ring elements with inner diameters in middle sizes between those of the first ring element 122 and the third ring element 124 may also be serially inserted between the two ring elements 122, 124. Therefore, from the axial mid-part 121a to any one of the two axial ends 121b, 121c of the inner periphery 121, the distance between the top plate 12 and the pole piece 14 is still gradually decreased. Preferably, an axial height of the first ring element 122 is smaller than those of the second or third ring elements 123, 124, so as to centralize the magnetic field between the inner periphery 121 and pole piece 14 more effectively. Thereby, a loudspeaker with a long stroke, small distortion, and good performances in generation of low-frequency sounds is accordingly obtained. Besides, with the top plate 12 made by the piled ring elements, the disclosed uneven inner periphery 121 can be easily completed by conventional and mass-produced washers without additional cost in molds for producing the said top plate 12. Therefore, the cost in manufacture can be further reduced.

As has been discussed above, based on the design of the inner periphery 121 of the top plate 12, the magnetic field between the inner periphery 121 and pole piece 14 is effectively centralized. And, therefore, a loudspeaker with this specifically designed top plate 12 may accordingly provides a long stroke, small distortion, and good performances in generation of low-frequency sounds.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A motor structure of loudspeaker, comprising:
a magnet with two opposite sides;
a top plate resting on one of the two sides of the magnet and jointly forming a central bore with the magnet;
a bottom plate supporting the magnet from the other side of the magnet; and
a pole piece formed on the bottom plate and extending into the central bore to face an inner periphery of the top plate and to form an air gap between the pole piece and the top plate,
wherein the inner periphery of the top plate has an axial mid-part at an axially middle belt thereof and two axial ends, with a distance between the pole piece and the axial mid-part being larger than another distance between the pole piece and any one of the two axial ends.

2. The motor structure of loudspeaker as defined in claim 1, wherein the top plate comprises a plurality of ring elements with at least two different sizes of inner diameters and being piled with each other, with one of the ring elements having the largest inner diameter forming the axial mid-part of the top plate, and two of the ring elements having the smallest inner diameters respectively form the axial ends of the top plate.

3. The motor structure of loudspeaker as defined in claim 2, wherein an axial height of the ring element forming the axial mid-part of the top plate is smaller than axial heights of the ring elements forming the axial ends of the top plate.

4. The motor structure of loudspeaker as defined in claim 2, wherein the piled ring elements are coaxial.

5. A motor structure of loudspeaker, comprising:
a magnet with two opposite sides;
a top plate resting on one of the two sides of the magnet and jointly forming a central bore with the magnet;
a bottom plate supporting the magnet from the other side of the magnet; and
a pole piece formed on the bottom plate and extends into the central bore to face an inner periphery of the top plate and to form an air gap between the pole piece and the top plate,
wherein the inner periphery of the top plate has an axial mid-part at an axially middle belt thereof and two axial ends, and, from the axial mid-part to any one of the two axial ends, a width of the air gap between the top plate and pole piece is decreased.

6. The motor structure of loudspeaker as defined in claim 5, wherein the top plate comprises a plurality of ring elements with at least two different sizes of inner diameters and being piled with each other, with one of the ring elements having the largest inner diameter forming the axial mid-part of the top plate, and two of the ring elements having the smallest inner diameters respectively form the axial ends of the top plate.

7. The motor structure of loudspeaker as defined in claim 6, wherein an axial height of the ring element forming the axial mid-part of the top plate is smaller than axial heights of the ring elements forming the axial ends of the top plate.
